(19) United States
(12) Patent Application Publication
(10) Pub. No.: US 2026/0299542 A1
(43) Pub. Date: Oct. 1, 2026

(54) System and Method for Repairing Damaged Parts with Integrated Removal and Deposition

(71) Applicant: Mitsubishi Electric Research Laboratories, Inc., Cambridge, MA (US)

(72) Inventors: William Yerazunis, Acton, MA (US); Devesh Jha, Cambridge, MA (US); Arvind Raghunathan, Medford, MA (US); Balasubramanian Krishnamoorthy, Portland, OR (US); Patrick Gambil, Pullman, WA (US)

(73) Assignee: Mitsubishi Electric Research Laboratories, Inc., Cambridge, MA (US)

(21) Appl. No.: 19/095,585

(22) Filed: Mar. 31, 2025

(51) Int. Cl. G05B 19/042; B23K 26/342; B33Y 50/02; G06T 7/00; G06T 7/73

(52) U.S. Cl. CPC G05B 19/0426; B23K 26/342; B33Y 50/02; G06T 7/001; G06T 7/75; G06T 2207/10028

(57) ABSTRACT

A method for repairing a damaged part with integrated removal and deposition includes scanning the damaged part to generate a high-density point cloud representing the geometry of the damaged surface, and comparing the damaged part point cloud with a reference model of the undamaged part to identify areas requiring material deposition to restore the geometry. The method also includes identifying obstructions to the material deposition at the identified areas requiring material deposition and clear identified obstruction by a removal process, and depositing repair material using a deposition tool to restore the damaged areas. Further, the method includes iteratively rescanning the part and updating the point cloud to refine subsequent removal and deposition steps. The removal and deposition processes are dynamically adjusted based on the updated point cloud.

### TECHNICAL FIELD

The disclosure relates generally to metal deposition systems and more particularly to system and method for repairing damaged parts with integrated removal and deposition.

### BACKGROUND

Additive manufacturing, for example, three dimensional (3D) printing is generally used to produce new parts, repair damaged parts, or perform a cladding operation on an object. During 3D printing of new objects, a head of the 3D printer cannot crash into the partially completed object because standard 3D printing always proceeds from Z− toward Z+, without ever backtracking to lower levels. However, while performing a repair or cladding operation, there is high probability that deposition head may impact the workpiece, especially for large, asymmetrical deposition heads such as wire-feed laser deposition heads.

Standard object interference computation can determine the interference situations of the head with the object fairly rapidly, and therefore can avoid such interferences to actually occur. However, the steps taken to prevent the interferences between the head and the object, generally, result into depositing less than the desired material, leaving internal void spaces. Although for some objects, cosmetic appearances are the only concern, other objects are structurally and functionally demanding, and, in such a scenario, the repaired objects with intentionally concealed internal defects such as interior voids are undesirable.

### SUMMARY

The disclosure provides for a method to improve the repair process performed by adding material by depositing molten metal onto a worn or damaged workpiece. The disclosure improves the ability of an additive manufacturing repair system the precision afforded by precise robotic positioning, and closed-loop dependability by reducing or eliminating the need for a highly skilled human to intuitively perform the metal-deposition repair operation, even when access to the damaged area is impaired.

This is done by adding a camera to the deposition head, plus an additional high-pressure control valve and gas jet nozzle, an internal database into the control system containing a CAD model or point cloud model of the correct and damaged part shapes, and a control algorithm capable of performing comparisons between the correct and damaged shapes. This allows the control system to dynamically generate the optimal toolpath for the next segment of the deposition process.

If the toolpath is in some way obstructed due to the particular shape of the damage (whether intrinsic to the correct shape or original material bent or dislocated as a result of the damaging event), the disclosure uses the built-in melting laser to establish a molten area on the obstruction, and then uses a pulse of high-pressure inert gas (preferably tapped from the additive manufacturing system's inert gas supply) to remove the obstruction and allow proper toolpath execution and deposition into the previously obstructed zone. If necessary, the removed obstruction can be replaced with newly deposited material after the completion of the obstructed volume's repair.

Another embodiment discloses a method for repairing a damaged part with integrated removal and deposition The method includes scanning the damaged part to generate a high-density point cloud representing the geometry of a damaged surface, and comparing the damaged part point cloud with a reference model of the undamaged part to identify areas/locations requiring material deposition to restore the geometry. The method also includes identifying obstructions to the material deposition at the identified areas/locations requiring material deposition and clear identified obstruction by a removal process, and depositing repair material using a deposition tool to restore the damaged areas/locations. Further, the method includes iteratively rescanning the part and updating the point cloud to refine subsequent removal and deposition steps. The removal and deposition processes are dynamically adjusted based on the updated damage part point cloud.

In embodiments, the dynamic adjustment of the removal and deposition processes based on the updated damaged part point cloud enables the process to self-correct to produce a good final part even in the event of a misplaced or failed deposition, whether by an external cause such as vibration, error in the prediction of melt deposit behavior modeling, or other cause.

In embodiments, removal of obstruction includes melting obstructions with a laser and clearing melted material using a high-pressure inert gas.

In embodiments, the deposition tool includes a wire feed laser melt deposition head.

Yet another embodiment discloses a system for repairing a damaged part with integrated removal and deposition. The system includes a scanning unit configured to generate high-density point clouds of the damaged part. The system also includes a material removal unit. Further, the system includes a droplet-based deposition head assembly configured to restore damaged areas by adding material. The system furthermore includes a controller configured to compare the damaged part's point cloud with a reference model, and identify areas/locations requiring material deposition to restore damaged part. The controller is also configured to identify obstructions to the material deposition at the identified areas/locations requiring material deposition and clear identified obstruction by a removal process. Further, the controller is configured to deposit repair material using a deposition head assembly to restore the damaged areas/locations, and iteratively rescan the damaged part and updating the damage part point cloud to refine subsequent removal and deposition steps. The removal and deposition processes are dynamically adjusted based on the updated damage part point cloud.

In embodiments, removal of obstruction includes melting obstructions with a laser and clearing melted material using a high-pressure inert gas.

In some embodiments, the deposition head assembly is a droplet based deposition head assembly, for example, a wire feed laser melt deposition head.

A further embodiment discloses a method for repairing a damaged part. The method includes scanning the damaged part to generate a high-density point cloud representing the geometry of a damaged surface of the damaged part, and comparing the damaged part point cloud with a reference model of the undamaged part to identify a deposition location requiring material deposition to restore the geometry. The method further includes depositing repair material using a deposition head assembly at the deposition location. Furthermore, the method includes iteratively rescanning the damaged part and updating the damaged part point cloud to identify next deposition locations for next deposition step,
wherein the deposition process is dynamically adjusted based on the updated damage part point cloud.

Although an accurate predictive simulation of the behavior of the material undergoing the laser melting and inert-gas jet removal of obstructing material can predict a large proportion of the activations of the material removal, it is preferable that these predictions be confirmed by re-scanning the damaged part to validate the predictions and to alter further removals and depositions as needed to result in a complete repair.

### BRIEF DESCRIPTION OF THE DRAWINGS

FIG. 1 shows a method for repairing damaged parts/objects with integrated removal and deposition.

FIG. 2 shows a method for identifying and removing obstructions in the repair path of damaged object.

FIG. 3 shows a method for identifying the location/area of deposition for the damaged object.

FIG. 4 shows a schematic of a system for repairing damaged parts/objects with integrated removal and deposition.

FIG. 5A shows a point cloud of undamaged part/object aligned with a point cloud of the damaged part used and depicting a first point of the point cloud of the damaged part as a first deposition location.

FIG. 5B shows a material deposited as a first droplet at a location of the first point of FIG. 5A and depicting a of the updated point cloud of the damaged part as a second deposition location.

FIG. 5C shows a material deposited as second droplet at the second deposition location of FIG. 5B.

FIG. 6A shows an example object having a crack depicting an upper surface of the object restricting/interfering with a laser used to deposit material at point corresponding to the central plane of the object and inside the crack.

FIG. 6B shows the object of FIG. 6A with material removed shown as bevels to access the point corresponding to central plane for deposition of material.

### DETAILED DESCRIPTION

### Overview of the Contribution to the Art

This overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

To repair expensive parts exposed to extreme conditions of heat, corrosion, and abrasive wear, material deposition techniques, for example, cladding, are generally used. Cladding involves repairing a worn workpiece by repeatedly depositing material on damaged part in a process similar to welding. Accordingly, cladding is a labor-intensive, extremely high-skilled operation, and thus expensive. Therefore, cladding-style repairs are usually economically justifiable only for expensive parts, for example, turbine blades from jet engines or custom modifications such as altering camshaft profiles of racing engines. Because of the human involvement and relatively large droplets that form the material deposit, the parts are, generally, re-machined to the correct size and shape after cladding.

Accordingly, the embodiments of the disclosure are based on a recognition for a system and method that automatically repair objects by depositing material and is capable of handling complex shapes with unpredictable damage. Also, some embodiments of the disclosure are based on the recognition that such method and system for repairing objects are configured to integrate material deposition and obstruction removal to provide repaired objects that have structural strength similar to the new object. This integration ensures that repairs proceed efficiently and precisely, even when faced with irregular geometries and physical barriers. The disclosure provides for the method and system based on the understanding that while material deposition is the dominant action, removal serves a critical supporting role by clearing paths for deposition and addressing areas that obstruct future repairs. This relationship—where removal is subordinate to and entirely guided by the needs of repair—forms the foundation of the method and system for repairing objects.

For automatically performing the repairing of an object, the method uses of high-density point cloud of the damaged part. The high-density point cloud provides a detailed, three-dimensional representation of the damaged part's geometry. By comparing point cloud of the damaged part with a reference model of the undamaged part, the system and the method identifies areas where material is missing and is to be added, and obstructions that either block deposition of the material or prevent access to repair zones. This dual analysis ensures that every removal action is purpose-driven and directly supports repair, creating a seamless workflow. The synergy between these functions ensures that the system operates as a cohesive whole, with removal actions generally used to enable and enhance the repair process. Additionally, the removal actions serve to correct situations where the damaged part has material projecting into spaces that should be empty, such as the large burrs that can be raised by a steel wire rope scraping against a structural component due to wear or misalignment of the rope-handling pulleys and fairleads.

In the embodiments, the point cloud of the damaged object carry specific features that enhance the system's ability to analyze and act. For instance, holes in the point cloud gaps in the triangulated mesh identified by edges that lack adjoining faces often indicate regions with obstructions to be removed, or voids where deposition is needed. The method, in embodiments, prioritizes, based on identification of such regions from the point cloud, the removal of obstructions that interfere with deposition and determines the minimum amount of material to be melted and removed to clear access for the repair process i.e., deposition of the material. This iterative approach ensures that only necessary removal actions are performed, minimizing waste and maximizing efficiency.

In the embodiments, the method selects obstructions that interfere with repair, beginning with the regions/areas of the object most intrusive to the deposition area. By simulating the deposition process, the method identifies such areas in the point cloud and prioritizes the area for removal of material, addressing both visible obstructions and subtle irregularities that might prevent future repairs. The system scans and analyzes the identified regions to define melting zones where the laser will be applied, followed by high-pressure inert gas to remove the melted material.

The method and system, in embodiments, operating on a droplet-based or piecewise-continuous cycle mechanism, uses continuously updated point cloud of the damaged part, obtained after depositing material, for next deposition cycle instead of relying on predefined toolpaths. In some embodiments, the method and system deposit material incrementally by identifying the areas of maximum deviation from the reference model i.e., model or point cloud of the original undamaged object, and adding material droplet by droplet, or in segments substantially smaller than a full repair. This precision ensures that each droplet contributes effectively to restoring the part's original geometry. Following each deposition or removal action, the method and system, in some embodiments, rescans the damaged area, updates the point cloud, and recalculates the next steps. This iterative feedback loop ensures dynamic adaptation to changing conditions and minor deviations in the expected behavior of the workpiece and deposition material during the cladding process, making the repair process efficient and reliable.

Accordingly, the synergy between deposition and removal together enable the method and system to automatically to handle even the most complex and irregular damage scenarios without or minimum human intervention. The dominance of deposition ensures that every system action is aligned with the primary goal of restoring the part, while removal plays a critical, supportive role by clearing pathways and addressing future obstacles. The reliance on high-resolution point cloud data to guide removal and deposition, creates a process that is both precise and adaptable. This integration of droplet-based deposition and targeted melting transforms repair into a seamless, intelligent, and highly effective operation.

### DETAILED DESCRIPTION OF THE FIGURES

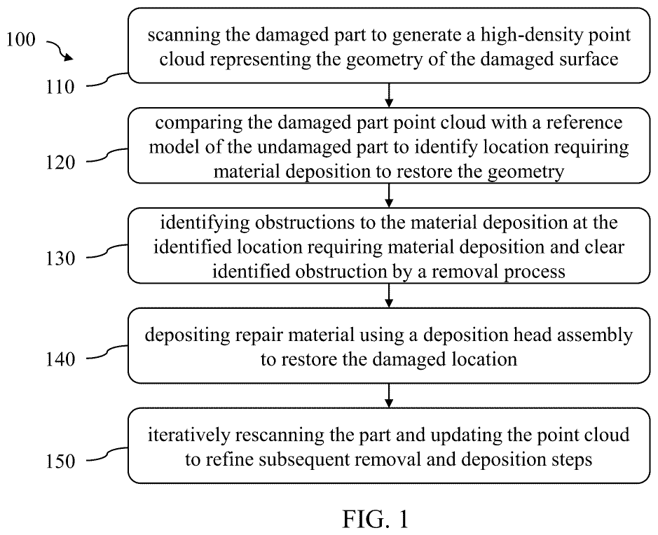

Referring to FIG. 1, an example method 100 for repairing damaged parts/objects with integrated removal and deposition is disclosed. The method 100 is performed by a processor based on instructions and any additional data or model to perform the method 100 by the processor are stored inside a memory. The method 100, at step 110 scans the damaged part to generate a high-density point cloud representing the geometry of the damaged object. In some embodiments, a scanning unit having at least one high resolution camera is used to scan the damaged object and create/generate the high density point cloud of the damaged object. In some embodiments, at least one camera may be mounted on a deposition head assembly of a repair system and the deposition head assembly is moved over the damaged object to scan the damaged object. In embodiments, the high density point cloud is a 3 dimensional point cloud of the damaged part. Upon generating the point cloud of the damaged object, the method 100, at step, 120 compares the damaged object's point cloud with a reference model of the undamaged object to identify areas requiring material deposition to restore the geometry, and obstructions that prevent deposition of the material. In some embodiments, the reference model is a 3d model, for example, CAD model such as .STEP file, .STL file, a .IGS file, or other formats, of the undamaged object, and the processor may convert the 3D model into a high density point cloud of the undamaged object, and then compares the point cloud of the damaged object with the point cloud of the undamaged object.

Upon identifying the areas that require material deposition and areas of obstructions to access the areas of the material deposition, the method, at step 130, applies a removal process to remove areas of obstructions. For so doing, the processor, in some embodiments, operates a laser to melt the obstructions and clear the melted material using a high-pressure inert gas. Alternatively, some embodiments may include a mechanical cutter similar to a milling machine cutter, capable of removing the obstructions using 3 to 5-axis milling operations. In some embodiments, the material is removed to allow an access of the deposition head assembly used to deposit material so fill the location of the damaged area.

Upon clearing the obstructions, the method 100, at step 140, the deposition head assembly deposits repair material to restore the damaged areas. The deposition head assembly can be configured to deposit the material in a droplet manner, or in a series of closely spaced individual deposits, or even in a continuous wire-fed mode. In some embodiments, the method 100, at step 150, iteratively rescans the damaged object after deposing the repair material on the damaged object, and updates/generates the point cloud to refine/identify subsequent removal and deposition steps based on the updated point cloud i.e. by comparing the updated point cloud of the damaged object with the reference model. In this manner, the method 100 enables the repair of the damaged object without or minimum human intervention and ensure quality of repair throughout the repaired areas.

In some embodiments, some or all of the steps of method 100 are overlapped and concurrently executed to makes the process of repairing the damaged object fast. For example, some or all of the actions in step 110 (scanning the damaged or partially repaired area), step 120 (comparison with the reference model to identify areas requiring material deposition), step 130 (identification of obstructions and clearing the obstructions), and step 140 (deposition of repair material) in a repeating loop as in step 150 can be overlapped and concurrently executed.

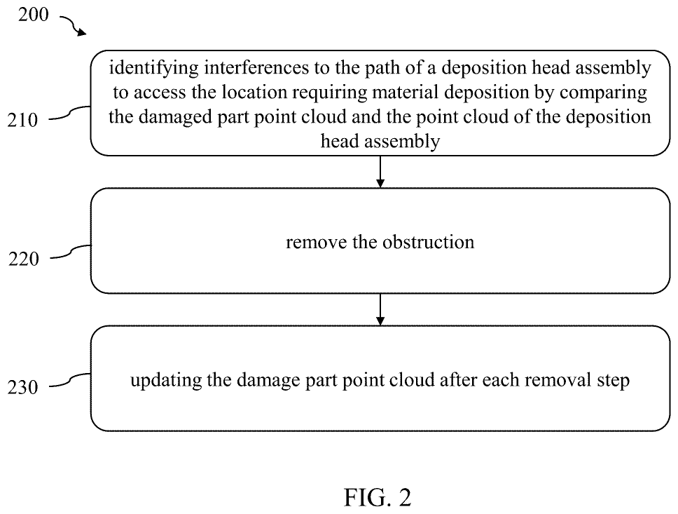

Referring to FIG. 2, a method 200 for identifying and removing obstructions in the repair of damaged object is disclosed. The method 200, in some embodiments, generates/uses a point cloud of the deposition head assembly to be used to deposit material to repair the damaged object. The method 200 at step 210, compares the point cloud of the deposition head assembly with the point cloud of the damaged object at location where the material is to be deposited to determine if there is enough space for the deposition head assembly to access the determined location of deposition of material. In some embodiments, the accessibility of the determined location of deposition is checked by determining Hausdorff distance between the damaged object's point cloud and point cloud of the deposition head assembly. Hausdorff distance is defined as the distance from a point in one set to the closest point in another set. The location of the deposition is determined to be accessible when the Hausdorff distance is greater than a threshold value. Otherwise, the processor determines the obstructions in the path of the deposition head assembly to access and deposit the material at the determined location of deposition.

Upon determining the obstruction to the path of the deposition head assembly, the method 200, at step 220, remove the obstruction. For so doing, in some embodiments, a laser is fired at the location of the obstruction to melt the obstruction and create a molten pool. Thereafter, the processor operates a valve to direct high pressure inert gas towards the molten pool to blow off the molten pool from the object, creating a path for the movement for the deposition head assembly towards the determined location of the deposition. Although a jet of high pressure inert gas is used to blow-off the removed material, other means of removal of material, such as, but not limited to, pressurized compressed air jet, violent shaking of the object, motion of the object with respect to gravitation such as tilting or inversion, application of a vacuum molten metal extractor, or combinations of these methods, or any other suitable method known in the art may also be utilized.

Although, firing laser to melt the obstruction is contemplated, other suitable means for removal of material, such as, but not limited to, conventional CNC milling and grinding, electric discharge machining (EDM), for example, flow-immersed sinker EDM, or any other suitable material removal method known in the art may also be utilized.

In embodiments, upon removing the obstructions, the method 200, at a step 230, rescan the damaged object to update the point cloud of the object which is then again compared with the point cloud of the deposition head assembly to determine whether the determined location of deposition is now accessible to the deposition head assembly. In this manner, method iteratively remove the obstructions from the path of the deposition head assembly to repair the damaged object.

In some embodiments, the processor determines the location of obstruction by determining the location of greatest interference between the point cloud of the object and the point cloud of the deposition head assembly. For so doing, the processor, in some embodiments, computes the Hausdorff distances for all points in the damaged part to the nearest point in the point cloud of the deposition head assembly, and sort the damaged part's point cloud from maximum to minimum Hausdorff distance. The location of greatest interference in general corresponds to the damaged point cloud point with the minimum Hausdorff distance.

In some embodiments, the location of greatest interference may itself be inaccessible to the deposition head assembly. To overcome these scenarios, the processor, in some embodiments, simulates the motion of the approaching deposition head assembly using point clouds of the damaged object and the point cloud of the deposition head assembly, and identifies the location of earliest interference, and remove that first, repeating until the location of greatest error can be accessed and metal deposited.

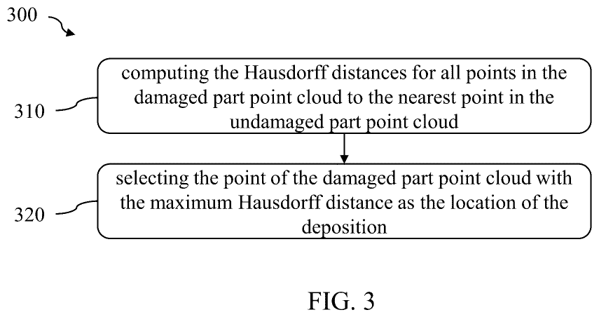

Referring to FIG. 3, a method 300 for identifying the location/area of deposition for the damaged object is disclosed, according to example embodiments of the disclosure. The method 300, at step 310, compares the point cloud of the damaged object with the point cloud of the undamaged object and computes the Hausdorff distances for all points in the damaged object to the nearest point in the undamaged object's point cloud. The method 300, at step 320, select the damaged object's point cloud point with the maximum Hausdorff distance as the location of the deposition. Upon performing the deposition at the location of the deposition, the processor rescan the damaged object and update the point cloud and determine the next location of deposition by comparing the updated point cloud of the damaged object with the point cloud of the undamaged project and computing the Hausdorff distances similar to the steps 310 and 320, perform the process iteratively to repair the damaged object. As this sequence of steps always deposits material, and assuming that there is no material impeding the deposition of material at the next location, then this process will always terminate with the damaged object repaired.

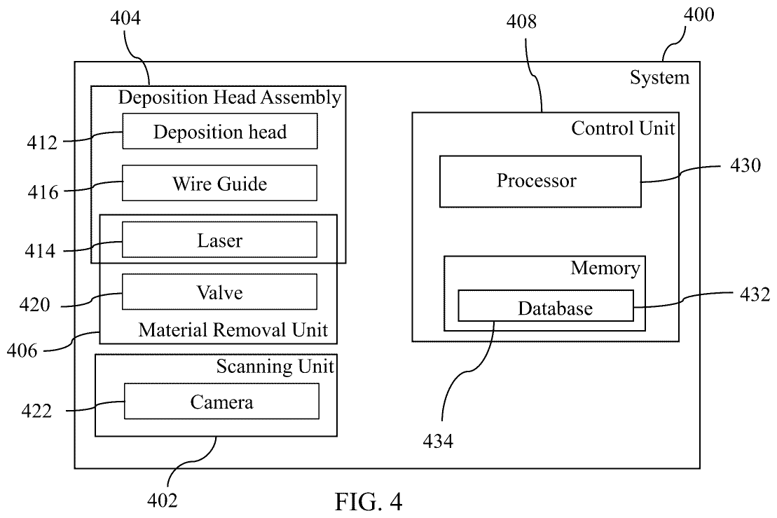

Referring to FIG. 4, an example system 400 for repairing a damaged object by performing one or more of the method 100, the method 200, and the method 300 is disclosed. As shown, the system 400 includes a scanning unit 402 to scan the damaged part/object, a deposition head assembly 404 to facilitate a deposition of material in droplet by droplet manner on the damaged object, a material removal unit 406 to facilitate a removal of material from the damaged object, and a control unit 408 to control one or more components of the system 400 including, but not limited to, the scanning unit 402, the deposition head assembly 404, the material removal unit 406.

In some embodiments, the system 400 includes a frame to position the damaged object and a mounting unit, for example, clamp, to hold the damaged object, during repair process. Further, the deposition head assembly 404 is configured to move in X, Y, and Z directions relative to the frame to perform the deposition of the material on the damaged object. In some embodiments, the deposition head assembly 404 includes a deposition head 412 with a laser 414 to generate and direct a laser beam towards the object at a desired location and a deposition wire guide 416 to hold and guide a deposition wire to generate droplet of deposition material. At the determined location of deposition, the deposition wire is melted by the laser beam emitted from the laser 414 to form a droplet of the deposition material on a surface of the damaged object. Further, in some embodiments, the material removal unit 406 includes at least one valve 420 adapted to be opened and closed to direct a high pressure inert gas toward a molten pool to remove/blow off the molten material from the object being repaired. In some embodiments, the scanning unit 402 includes at least one high resolution camera 422 suitable to scan the damaged object held on the frame. Further, it may be envisioned that the scanning unit 402 is also arranged to move in X-Y-Z direction to scan all the details of the damaged object. In some embodiments, the scanning unit 402 may be mounted on the deposition head assembly 404.

The deposition head assembly 404, the material removal unit 406, and the scanning unit 402 are communicatively coupled to the control unit 408 and are controlled by the control unit 408 to enable automatic repair of the damaged object without any human intervention or minimum human intervention. As shown, the control unit 408 i.e., controller 408 includes a processor 430 and a memory 432 to store instructions and models to carry out the repairing the damaged object. In embodiments, the memory 432 stores instruction corresponding to method 100, the method 200, the method 300 and any other instructions to successfully repair the damaged object.

The processor 430 may comprise a micro-processor and other circuitry that retrieves and executes method 100 from memory 432. Processor 430 may be implemented within a single processing device but may also be distributed across multiple processing devices or sub-systems that cooperate in executing program instructions. Examples of processor 430 include general purpose central processing units, graphical processing units, digital signal processors, application specific processors, and logic devices, as well as any other type of processing device, combinations, or variations thereof.

Memory 432 may comprise any computer readable storage media readable by processor 430 and capable of storing instruction related the method 100 and reference models. Memory 432 may include volatile and nonvolatile, removable and non-removable media/memory implemented in any method or technology for storage of information, such as computer readable instructions, data structures, program modules, or other data. Examples of memory 432 include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations memory 432 may also include computer readable communication media over which at least some of method 100 may be communicated internally or externally. Memory 432 may be implemented as a single storage device but may also be implemented across multiple storage devices or sub-systems co-located or distributed relative to each other. Memory 432 may comprise additional elements capable of communicating with processor 430 or possibly other systems.

In some embodiments, the memory 432 may include a database 434 to store reference models of various objects. In some embodiments, the reference models are stored as CAD models. In some embodiments, the reference models are stored in the form of point clouds. The processor 430 is configured to extract the reference model corresponding to the damaged object from the database 434. In some embodiments, the processor 430 selects the reference model associated with the damaged object to be repaired based on input received from a user via a user interface of the system 400. In some embodiments, the system 400 allows a user to upload a file corresponding to the reference model from an external source. In some embodiments in which CAD models are stored as the reference models, the processor 430 converts the reference CAD model into a high density point cloud of the undamaged object.

Further, before comparing the point cloud of the damaged object with the point cloud of the corresponding undamaged object, the processor 430 may refine the point cloud of the undamaged object based on the instruction stored in the memory 432. The refinement is performed to ensure that the point cloud of the undamaged object is a high density point cloud. The desired density of the point cloud of the undamaged object is the resolution of minimum feature that the deposition head 412 is configured to deposit or several times finer than the resolution of the deposition head 412. For example, for a deposition head adapted to deposit at approximately one millimeter resolution, a density of 3 to 10 points per millimeters for the point cloud model is desirable. In some embodiments, the CAD model is converted into high density point cloud by using any suitable method, such as, but not limited to, Poisson disk, ball pivoting, recursive refinement of a triangular mesh, or any other method known in the art.

However, one challenge of most point cloud conversion methods is that, during conversion, the surface is sampled stochastically and thus may not capture one or more of sharp edges or corners in the CAD model. Thus, a part repaired from such a point cloud will have ragged edges and rounded corners. Therefore, the processor 430 is configured to add/generate the corner and edge points via a deterministic using one or more well knows methods. An example method for triangle-facet shaped models (such as STL models) is now described. The processor 430, each triangle in the CAD model, the processor identifies TP1, TP2, and TP3 as the vertices of the triangle. Thereafter, the processor 430, for the triangle edge defined by TP1 to TP2, generates the edge pointset EP1 by using the two-point form of a line. For so doing, the processor set the Line length as ‘LL’ as the distance from TP1 to TP2. As the selected resolution of the point cloud is 10 points per millimeter, the processor 430 samples the line from TP1 to TP2 and length LL mm, the processor 430 generates 10 multiplies by ‘LL’ samples. Thereafter, the processor generates new points for the point cloud by using the two-point version of a line as follows:

$$New Point = ( TP 1 * tau + ( TP 2 * ( 1 - tau ) ) , for each tau being 0 ,$$

$$1 / ( 10 * LL ) , 2 / ( 10 * LL ) , … , ( 10 * LL - 1 ) / ( 10 * LL ) .$$

An alternative method is repeated subdivision of the triangular model, where a single triangle is replaced by two, three, or four sub-triangles. This subdivision repeats until the density of vertices is acceptably high (preferably in the sub millimeter range) In this method, the set of all vertices then directly becomes the high density point cloud

After generating the new points, the processor 430 adds the generated new points to the stochastic-sampled point set to ensures adequately dense point cloud having accurate part edges and corners in set EP1. In this manner, the processor 430 updates and refines the entire point cloud of the undamaged object to ensure that the point cloud of the undamaged object includes sharp corners and edges of the object.

### Example Implementation

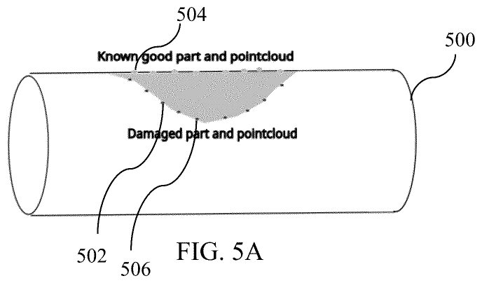

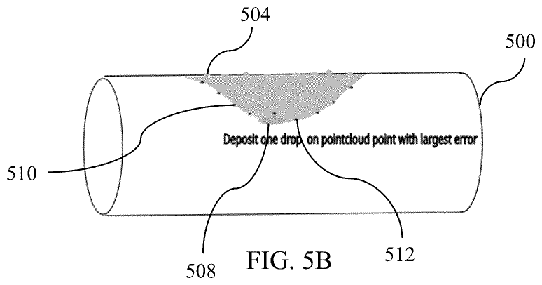

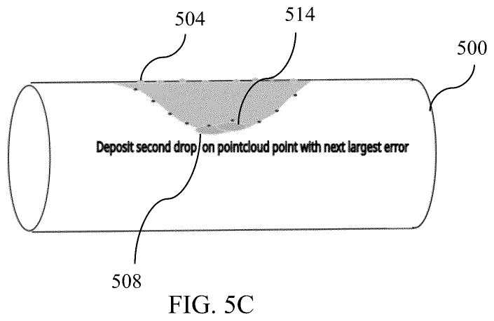

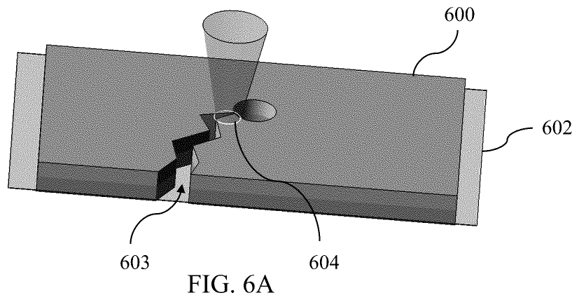

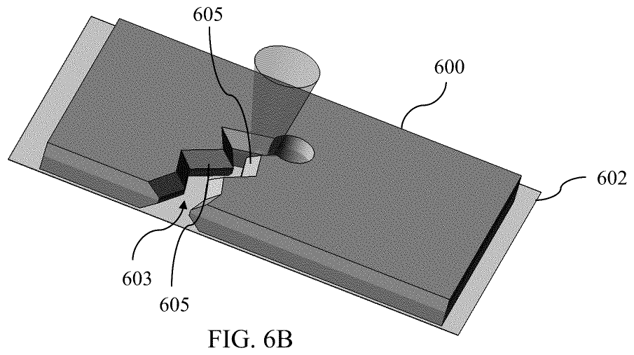

An example implementation is described with reference to damaged objects 500, 600 shown in FIGS. 5A to 5C and 6A-6B.

For repairing the damaged object, also referred to as workpiece, the workpiece is mounted on the frame and clamped on the frame at a desired orientation. Upon suitably mounting the workpiece on the frame, the user actuates the system 400 for repairing the object. For so doing, the processor 430 operates the scanning unit 402 to scan the workpiece and based on the scan, the processor 430 creates a high density point cloud of the workpiece. The scanning unit 402 generates the point cloud, preferably with a resolution of at least 0.1 mm to ensure identification of damage and obstructions of the workpiece.

Upon generating the point cloud of the workpiece, the processor 430 recalls from memory the reference model of the undamaged object corresponding to the workpiece and compares the reference model with the point cloud of the damaged object. In some embodiments, before comparing, the processor 430, in some embodiments, refines the reference model and converts the reference model into a high density point cloud of the undamaged object such that the high density point cloud includes sharp edges and corners of the undamaged/original object corresponding to the workpiece, while in other embodiments, the undamaged object's high density point cloud is computed once and then stored in a memory accessible to the processor 430. The processor 430 refines and converts the reference model into the point cloud, preferably in one of the manners described into foregoing description. Also, in some embodiments, before comparing the point clouds of the workpiece and the original/undamaged object, the processor 430 aligns the two point clouds in translation and rotation, thereby removing any positioning error due to clamping ambiguity in the actual and damaged object relative to the machine's frame of reference. One method is to minimize the sum of the individual Hausdorff distances. Referring to FIG. 5A, the point cloud 502 of the damaged object 500 is shown aligned with the point cloud 504 of the corresponding undamaged object.

For comparing the two point clouds, the processor 430 computes the Hausdorff distances for all points in the workpiece to the nearest point in the undamaged object point cloud, and sort the damaged object's point cloud from maximum to minimum Hausdorff distance. Thereafter, the processor 430 selects the point cloud point with the maximum Hausdorff distance, which will be the first point, shown as 506 in FIG. 5A, of the sorted list, and determines the location of the first point as the deposition location.

Upon determining first point 506 as the deposition location, the processor 430 actuates and controls the deposition head assembly 404 and deposit material as droplet 508, shown in FIG. 5B, at the first point. Thereafter, in embodiments, the processor 430 again actuates and control the scanning unit 402 to scan the partially repaired object and creates an updated point cloud 510, shown in FIG. 5B, of the damaged object having the material deposited at the first point 506. The processor 430 then compares the updated point cloud 510 of the damaged object i.e., point cloud of the partially repaired object with the point cloud 504 of the undamaged object to identify next deposition location, for example, a second deposition location 512. For so doing, the processor 430 computes Hausdorff distances for all points in the updated point cloud to the nearest point in the undamaged object, and determines the next deposition location as the point with maximum Hausdorff distance. Thereafter, the processor 430 actuates the deposition head assembly to deposit the material 514, shown in FIG. 5C at the identified second deposition location 512. The processor 530 iteratively performs scanning to generate updated point cloud after each deposition, identify next deposition location, and deposit the material to repair the undamaged object at the next deposition location until the point cloud of the damaged object matches with the point cloud of the undamaged object.

In this manner, although processor 430 fills damage from bottom to top, in a fairly optimal way, the processor 430 does not check the feasibility of access of the identified deposition location by the deposition head assembly with respect to possible interference between the deposition head assembly and the damaged object. For example, as shown in FIG. 6A, the deposition location for a damaged object 600 is a middle plane 602 of the plate as this is the location of maximum Hausdorff distance. However, the points at the middle plane 602 associated with a crack 603 of the damaged object 600 is not accessible to deposition head assembly 404, and if the laser is directed towards without removing the obstructions, sufficient power of the laser beam is not delivered to the central/middle plane 602 because the central plane 602 is accessible only through a relatively narrow crack. In this scenario, the edges of the crack 603 block a considerable part of the converging laser beam and the vast majority of the laser power is deposited on the upper surface of the plate, as shown by the beam perimeter 604. Because relatively little energy is deposited in the shadowed interior, the interior part of the damaged object 600 never achieves sufficient temperature to melt and form a weld pool, yielding a poor quality fusion to the interior part, while the outer parts of the repair will be of high quality and conceal the interior defect.

To avoid such a situation, the processor 430, in some embodiments, checks the accessibility of the identified location of deposition by the deposition head assembly 404 before initiating deposition at the location, and determines the obstructions as the interference to the path of travel of the deposition head assembly 404 to the determined deposition location. For so doing, in some embodiments, the processor 430 uses a point cloud of the deposition head assembly 404 including the laser beam, but excluding the final 2 to 4 mm of the laser beam (that being the part of the laser beam focused on the melt zone and therefore should intercept the laser beam), and compares the point cloud of the deposition head assembly 404 with the point cloud of the damaged object, for example, object 600, to identify obstruction to the travel path.

In some embodiments, for comparison, the processor 430 calculates the Hausdorff distance between the two point clouds by positioning the deposition head assembly 404 at a correct position in the point cloud of the damaged object that enables access of deposition location and deposition of the droplet at the deposition location. Thereafter, the processor 430 determines that the determined deposition location is accessible when the Hausdorff distance is greater than a threshold value. In such case, the processor 430 controls the deposition head assembly 404 at the identified location. Otherwise, the processor 430 determines the obstruction in the path of the deposition head assembly 404 to access and deposit the material at the determined location.

Upon determining the obstruction to the path of the deposition head assembly 404, processor 430 identifies the locations of one or more obstructions, and operates the material removal unit 406 to remove the obstruction. For so doing, in some embodiments, the processor 430 actuates and fires a laser at the identified location of the obstruction to melt the obstruction and create a molten pool. Thereafter, the processor 430 operates the valve 420 to direct high pressure inert gas towards the molten pool to blow off the molten pool from the object, creating a path for the movement for the deposition head assembly 404 towards the determined location of the deposition. In embodiments, upon removing the obstruction, the damaged object is rescanned to update the point cloud of the object which is then again compared with the point cloud of the deposition head assembly to determine whether the determined location of deposition is accessible to the deposition head assembly. In this manner, method iteratively remove the obstructions from damaged object. For example, as shown in FIG. 6B, the processor 430 controls the material removal unit 406 to remove the material at the edges of the crack 603 to bevel 605 out the edges of the crack 603, and widens the crack 603 enable access of the points at the middle plane 602 to deposit the material.

In some embodiments, the processor 430 determines the location of obstruction by determining the location of greatest interference between the point cloud of the damaged object and the point cloud of the deposition head assembly. For so doing, the processor 430, in some embodiments, computes the Hausdorff distances for all points in the damaged object to the nearest point in the point cloud of the deposition head assembly 404, and sort the damaged part's point cloud from maximum to minimum Hausdorff distance. The location of greatest interference corresponds to the damaged point cloud point with the minimum Hausdorff distance.

In some embodiments, the location of greatest interference may be inaccessible to the deposition head assembly 404. To overcome these scenarios, the processor 430, in some embodiments, simulates the motion of the approaching deposition head assembly 404 using point clouds of the damaged object and the point cloud of the deposition head assembly 404, and identifies the location of earliest interference, and remove that first, repeating until the location of deposition is accessed.

Upon removal of the obstructions, the processor 430 operates the deposition head assembly 404 to deposit the material by droplet deposition or piecewise continuous deposition at the determined deposition location, i.e., the point of greatest error in the point cloud of the damaged object and the point cloud of the undamaged object. Thereafter, the processor 430 actuates the scanning unit 402 to rescan the updated workpiece and generates the updated point cloud of the damaged object and proceed with determination of the next deposition location and removal and deposition of material to repair the damaged object in a similar manner. The processor 430 performs the deposition and removal process iteratively until the damaged object is completely repaired and the point cloud of the repaired object matches with the point cloud of the undamaged object.

In some embodiments, the processor 430 may clump nearby points with the maximum Hausdorff point i.e., point of greatest error, to form a piecewise continuous laydown path for deposition. By generating the continuous path for deposition, the processor 430 minimizes the number of rescans required to update the damaged object point cloud. In some embodiments, the processor 430 evaluates the distances between the maximum Hausdorff distance point to the second-to-maximum, third-to-maximum, etc. If these points are effectively adjacent to the maximum Hausdorff distance point and are accessible with minimum change of direction and velocity for the deposition head assembly 404, then processor 430 generates a continuous path for material deposition and deposit the material on the selected points in one continuous laydown operation. Also, the processor 430 removes any rescan points that are outside of the good part's point cloud or outside of the original part's CAD model before evaluating the points that can be clumped together. In this manner, the system 400 and method repair the object without or minimum human intervention while ensuring the quality of repair throughout the repaired portion of the object.

1. A method for repairing a damaged part with integrated removal and deposition, comprising:
scanning the damaged part to generate a high-density point cloud representing the geometry of a damaged surface of the damaged part;
comparing the damaged part point cloud with a reference model of the undamaged part to identify location requiring material deposition to restore the geometry;
identifying obstructions to the material deposition at the identified location requiring material deposition and clear identified obstruction by a removal process;
depositing repair material using a deposition head assembly to restore the identified location requiring material deposition; and
iteratively rescanning the damaged part and updating the damaged part point cloud to refine subsequent removal and deposition steps,
wherein the removal and deposition processes are dynamically adjusted based on the updated damage part point cloud.

2. The method of claim 1, wherein identifying and removing obstructions comprises
identifying interferences to the path of the deposition head assembly to access the location requiring material deposition by comparing the damaged part point cloud and the point cloud of the deposition head assembly, and
updating the damage part point cloud after each removal step to ensure accessibility for subsequent deposition processes.

3. The method of claim 2, wherein the interferences to the path of the deposition head assembly is identified based on Hausdorff distance computed between point cloud of the deposition head assembly and the damaged part point cloud.

4. The method of claim 2, wherein interferences to the path of the deposition head assembly is determined by simulating the path of the travel of the head assembly to access the identified location requiring material deposition.

5. The method of claim 1, wherein comparing the damaged part point cloud with the reference model includes converting and refining the reference model into a high density point cloud of the undamaged part.

6. The method of claim 5, wherein comparing the damaged part point cloud with the reference model comprises
computing the Hausdorff distances for all points in the damaged part point cloud to the nearest point in the undamaged part point cloud, and
selecting the point of the damaged part point cloud with the maximum Hausdorff distance as the location requiring material deposition,
wherein damaged part the point cloud is updated after performing deposition at identified area of the deposition, and the updated point cloud is utilized to determine the next location requiring material deposition.

7. A system for repairing a damaged part with integrated removal and deposition, comprising:
a scanning unit configured to generate high-density point cloud of the damaged part;
a material removal unit to remove material from the damaged part;
a deposition head assembly configured to restore damaged areas by adding material; and
a controller configured to:
compare the damaged part's point cloud with a reference model;
identify location requiring material deposition to restore damaged part;
identify obstructions to the material deposition at the identified location requiring material deposition and clear identified obstruction by a removal process using the material removal unit;
deposit repair material using a droplet-based deposition head assembly to restore the identified location requiring material deposition; and
iteratively rescan the damaged part and updating the damage part point cloud to refine subsequent removal and deposition steps,
wherein the removal and deposition processes are dynamically adjusted based on the updated damage part point cloud.

8. The system of claim 7, the controller is configured to identify and remove obstructions by
identifying interferences to the path of the deposition head assembly to access the location requiring material deposition by comparing the damaged part point cloud and the point cloud of the deposition head assembly, and
updating the damage part point cloud after each removal step to ensure accessibility for subsequent deposition processes.

9. The system of claim 8, wherein the controller is configured to identify interferences to the path of the deposition head assembly based on Hausdorff distance computed between point cloud of the deposition head assembly and the damaged part point cloud.

10. The system of claim 8, wherein the controller is configured to identify interferences to the path of the deposition head assembly by simulating the path of the travel of the head assembly to access the identified location requiring material deposition.

11. The system of claim 7, wherein comparing the damaged part point cloud with the reference model includes converting and refining the reference model into a high density point cloud of the undamaged part.

12. The system of claim 11, wherein comparing the damaged part point cloud with the reference model comprises
computing the Hausdorff distances for all points in the damaged part point cloud to the nearest point in the undamaged part point cloud, and
selecting the point of the damaged part point cloud with the maximum Hausdorff distance as the location requiring material deposition,
wherein damaged part the point cloud is updated after performing deposition at identified area of the deposition, and the updated point cloud is utilized to determine the next location requiring material deposition.

13. The system of claim 7, wherein the scanning unit generates point clouds with a resolution of at least 0.1 mm to ensure identification of damage locations and obstructions.

14. A method for repairing a damaged part, comprising:
scanning the damaged part to generate a high-density point cloud representing the geometry of a damaged surface of the damaged part;
comparing the damaged part point cloud with a reference model of the undamaged part to identify a deposition location requiring material deposition to restore the geometry;
depositing repair material using a deposition head assembly at the deposition location; and
iteratively rescanning the damaged part and updating the damaged part point cloud to identify next deposition locations for next deposition step,
wherein the deposition process is dynamically adjusted based on the updated damage part point cloud.

15. The method of claim 14, wherein comparing the damaged part point cloud with the reference model includes converting and refining the reference model into a high density point cloud of the undamaged part.

16. The method of claim 15, wherein comparing the damaged part point cloud with the reference model comprises
computing the Hausdorff distances for all points in the damaged part point cloud to the nearest point in the undamaged part point cloud, and
selecting the point of the damaged part point cloud with the maximum Hausdorff distance as the deposition location,
wherein damaged part the point cloud is updated after performing deposition at identified area of the deposition, and the updated point cloud is utilized to determine the next deposition location.

17. The method of claim 14 further comprising
identifying obstructions to the material deposition at the identified first deposition location requiring material deposition and clear identified obstruction based on the identification of the obstruction before depositing repair material using a deposition head assembly at the identified deposition location,
wherein obstructions are identified and removed for each deposition location before depositing the material.

18. The method of claim 17, wherein identifying and removing obstructions comprises
identifying interferences to the path of a deposition head assembly to access the deposition location requiring material deposition by comparing the damaged part point cloud and the point cloud of the deposition head assembly, and
updating the damage part point cloud after each removal step to ensure accessibility for subsequent deposition process.

19. The method of claim 18, wherein the interferences to the path of the deposition head assembly is identified based on Hausdorff distance computed between point cloud of the deposition head assembly and the damaged part point cloud.

20. The method of claim 18, wherein interferences to the path of the deposition head assembly is determined by simulating the path of the travel of the deposition head assembly to access the identified location requiring material deposition.
